(19) United States
(12) Patent Application Publication
(10) Pub. No.: US 2018/0285056 A1
(43) Pub. Date: Oct. 4, 2018

(54) ACCESSORY HUMAN INTERFACE DEVICE

(71) Applicant: Microsoft Technology Licensing, LLC, Redmond, WA (US)

(72) Inventors: Ross Garrett Cutler, Clyde Hill, WA (US); Antti Pekka Kelloniemi, Issaquah, WA (US)

(21) Appl. No.: 15/472,094

(22) Filed: Mar. 28, 2017

(51) Int. Cl. G06F 3/16; G10L 25/48; G06F 3/01; G10L 25/84

(52) U.S. Cl. CPC G06F 3/165; G10L 25/48; G10L 25/84; G06F 3/013; G06F 3/012

(57) ABSTRACT

Non-limiting examples describe an accessory device that is configured to improve voice activity detection processing and communication with an application executing on a host device. A new configuration for an accessory device is disclosed herein that comprises a dual microphone array for enhanced voice activity detection processing. In an exemplary configuration, the accessory headset comprises a first boom and a second boom that each comprise at least one microphone, collectively forming a microphone array for capture of an audio signal. A voice activity detection state of the accessory device as well as voice activity detection processing results may be generated by the accessory device and transmitted to the application through a human interface device (HID) communication protocol, for example, that is used to initiate a communication session between the accessory device and an application executing on a host device. In one example, an accessory device is a headset device.

### BACKGROUND

Considering use of an accessory device such as a headset, speakerphone, or other audio accessory for communication with a communication application: when a user of is talking, it is beneficial for the communication application to automatically adjust the signal gain to take into account changes in talking level, distance from microphone, etc. The communication application analyzes the received signal to detect voice activity and level of speech. This is usually difficult because the microphone may capture voices of other people when the device user is not speaking, recognizing the babble noise as “speech”. This results in adding high gain to the signal while user is not speaking, effectively increasing noise level, as the software logic tries to increase the “speech” level. To avoid this, headset users have learned or are instructed to mute their microphones manually when they are not talking.

The accessory device is also actively sending the audio signal to the host device at times when user has not muted the microphone. This is necessary, as the host device is expected to analyze the signal and decide whether it contains speech or not. Typically, redundant processing occurs where voice activity detection processing is performed by an accessory device or a host device and then re-performed by an application that is using an audio signal. Such redundant cascaded processing is inefficient and can lead to latency and performance issues for an application. This is a result of inefficient communication between an accessory device and an application executing on a host device.

Further, most accessory devices are limited when executing voice activity detection processing. Accuracy in assessing an audio signal is an issue where typical accessory devices can detect a fair number of false positives when it comes to determining whether an audio signal is speech. Moreover, accessory devices are limited in that they are unaware as to what application is receiving a processing result and how that application intends to use the processing result.

### SUMMARY

In regard to the foregoing issues, examples of the present application are directed to the general technical environment related to improving an accessory device for voice activity detection as well as improving communication between an accessory device and an application executing on a host device.

Non-limiting examples describe an accessory device that may be configured to improve voice activity detection processing and communication with an application executing on a host device. A new configuration for an accessory device is disclosed herein, where the accessory device comprises a dual microphone array for enhanced voice activity detection processing. In an exemplary configuration, the accessory headset comprises a first boom and a second boom that each comprise at least one microphone, collectively forming a microphone array for capture of an audio signal. In one example, an accessory device may be a headset device. The accessory device may connect with the host device through a communication session, where an exemplary human interface device (HID) communication protocol is used to enable direct communication between the accessory device and an application executing on the host device. A voice activity detection state of the accessory device as well as voice activity detection processing results may be transmitted to the application through the communication session. An application may be detected that is executing in a foreground of the host device. In some examples, command processing through the HID communication protocol may be configured to identify a specific application that is executing on a host device, where such information can be utilized by an accessory device to tailor communications for a specific application. For instance, an exemplary accessory device may be programmed to work with a suite of applications (e.g. of a platform), where data transmission may differ based on the identified application.

The accessory device may capture one or more audio signals. In some instances, a user may have one or more microphone booms (of an accessory device) positioned away from the user's mouth, which could lead to difficulty in capturing audio signals. An exemplary accessory device may be configured to detect such an instance and notify a user. Examples of notification may comprise but are not limited to: audio output through the accessory device, visual indication on the accessory device and data transmission provided to an application for the application to provide a notification to a user, among other examples.

The accessory device may execute voice activity detection processing on an audio signal. In one example, execution of the voice activity detection processing comprises applying a trained voice activity detection model to determine a voice activity detection processing result. Application of the trained voice activity detection model may comprise evaluating one or more of: a sound level of an audio signal detected by a microphone array of the exemplary accessory device, detection of one or more of a head position and a gaze position of a user who wears the accessory device, a state of a signal path of the accessory device and a confirmation of a user-specific speech pattern pertaining to a captured audio signal. An exemplary processing result may be generated based on an evaluation of the audio signal. The processing result may be transmitted to the detected application through the established communication session. In one example, a voice activity detection processing result is transmitted to the application even when the voice activity detection state indicates that a signal path of the accessory device is muted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A illustrates an exemplary system implementable on one or more computing devices on which aspects of the present disclosure may be practiced.

FIG. 1B illustrates an exemplary accessory device with which aspects of the present disclosure may be practiced.

FIG. 2 is an exemplary method related to application processing by an application executing on a host device with which aspects of the present disclosure may be practiced.

FIG. 3 is an exemplary method related to communication, by an accessory device, with a host device with which aspects of the present disclosure may be practiced.

FIG. 4 is a block diagram illustrating an example of a computing device with which aspects of the present disclosure may be practiced.

FIGS. 5A and 5B are simplified block diagrams of a mobile computing device with which aspects of the present disclosure may be practiced.

FIG. 6 is a simplified block diagram of a distributed computing system in which aspects of the present disclosure may be practiced.

### DETAILED DESCRIPTION

Non-limiting examples of the present disclosure describe a human interface device (HID) communication protocol that enables communication between an application, executing on a host device, and an HID accessory device. A connection with an HID accessory device may be detected by a host device (e.g. HID host) that is executing an application. The application utilizes audio/sound signals and processing results provided by the HID accessory device. An exemplary communication session is established through an HID communication protocol that is configured to enable direct communication between the application and an HID accessory device. As an example, frame data may be continuously collected and transmitted by an HID accessory device to an application. The HID communication protocol enables the HID accessory device to synchronize specific data into frames that can be transmitted to an application. For example, frame data may comprise any of: an audio signal, a processing result of voice activity detection (VAD) processing for the audio signal by the HID accessory device and an indication of the voice activity detection state of the HID accessory device. An exemplary HID accessory device may be configured to continuously transmit a VAD processing result to an application even in cases when the HID accessory device is muted. Additionally, a VAD state of the HID accessory device may be continuously provided to the application. The application may utilize the VAD processing result and VAD state of the accessory device to adjust service of the application as described herein.

The HID communication protocol may be an extension of a standard that is used for communication between a host device and an accessory device. Previously existing standards may only enable accessory devices to pass signal data to a host device without accounting for an interaction between an application and an accessory device. In previous instances, the host device acts as an intermediary by forwarding signal data to an application/service, which is executing on the host device. In such cases, an application redundantly performs voice activity detection (VAD) even though the accessory device or host device may have already performed VAD processing. This redundant processing is inefficient and can lead to latency and performance issues for an application. The HID communication protocol of the present disclosure is configured to enable an HID accessory device to directly communicate with an application of a host device as well as tailor communications in an application-specific manner for the application. For instance, an application programming interface (API) or multiple APIs may be configured to detect execution of specific applications and enable a specific application to interface directly with an accessory device for management of communication transmissions as well as service management for services provided by the specific application. While some examples can be configured to detect and work with a suite of specific applications, it is to be understood that HID protocol examples described herein are not required to detect a specific application and can be configured to focus on communication of HID data to from an HID accessory device to any application executing on a host device.

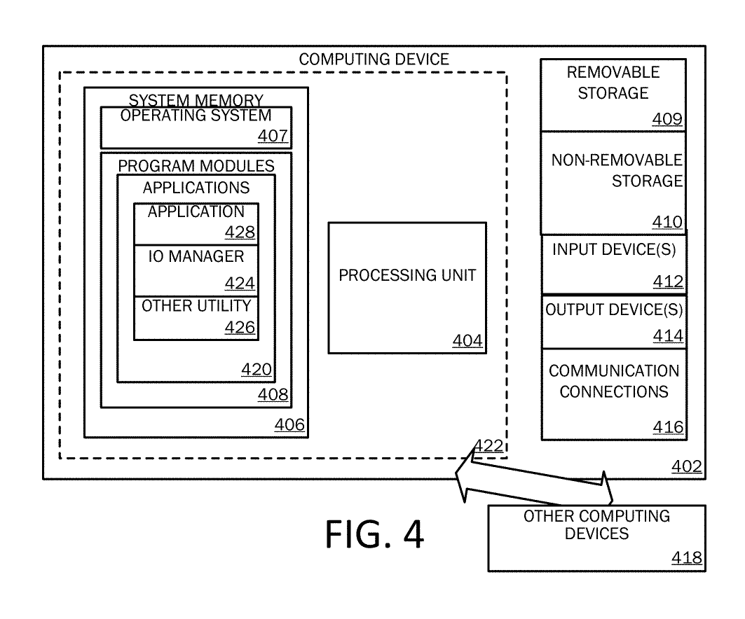

As an example, the HID protocol may be an extension of a Bluetooth HID standard that can adapt an existing Bluetooth protocol to enable application-specific communications with an accessory device. As another example, the HID protocol may be an extension of a universal serial bus (USB) standard that can adapt an existing USB protocol to enable application-specific communications with an accessory device. A host device may be any computing device that is configured to execute on or more applications/services. Examples of computing devices are provided in the description of FIGS. 4-6 provided herein. As an example, an accessory device may be a headset device. However, an accessory device is not limited to such an example and may be any type of device including but not limited to: mobile computing devices, control devices (e.g. remote controls, keyboards, mice) and audio devices, among other examples.

Accordingly, the present disclosure provides a plurality of technical advantages including but not limited to: an exemplary human interface device (HID) communication protocol that enables direct interaction between an application and an HID accessory device, a new configuration for an accessory device that improves accuracy in VAD detection, improved processing for voice activity detection, improved signal path control, more efficient operation of processing devices (e.g., saving computing cycles/computing resources, power consumption, etc.) through improved accuracy in voice activity detection and improved communication between host devices and accessory devices (using the HID communication protocol), improved service of applications communicating with accessory devices, improving user interaction with exemplary applications receiving HID data and extensibility to integrate processing operations described herein in a variety of different applications/services, among other examples.

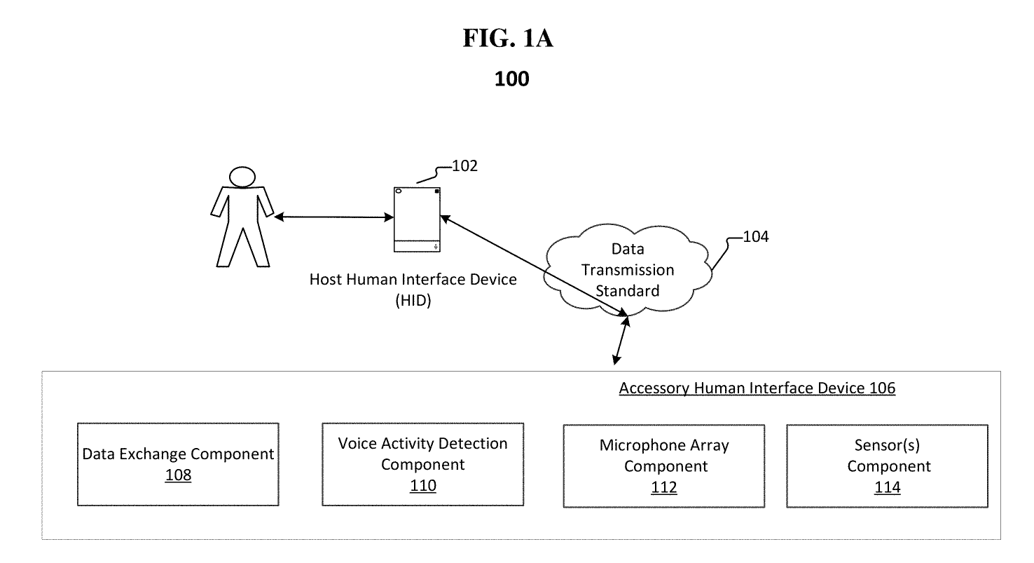

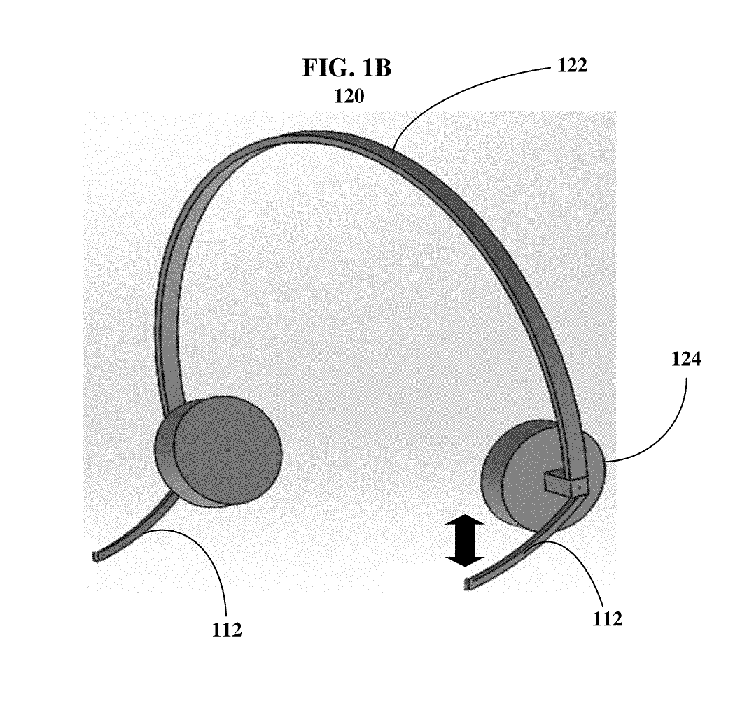

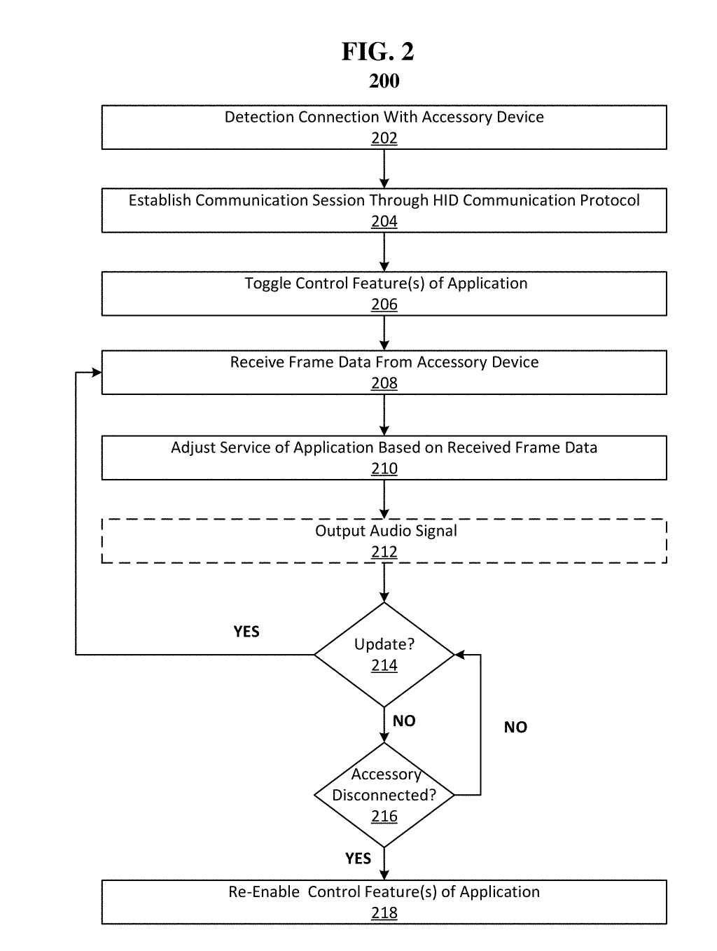

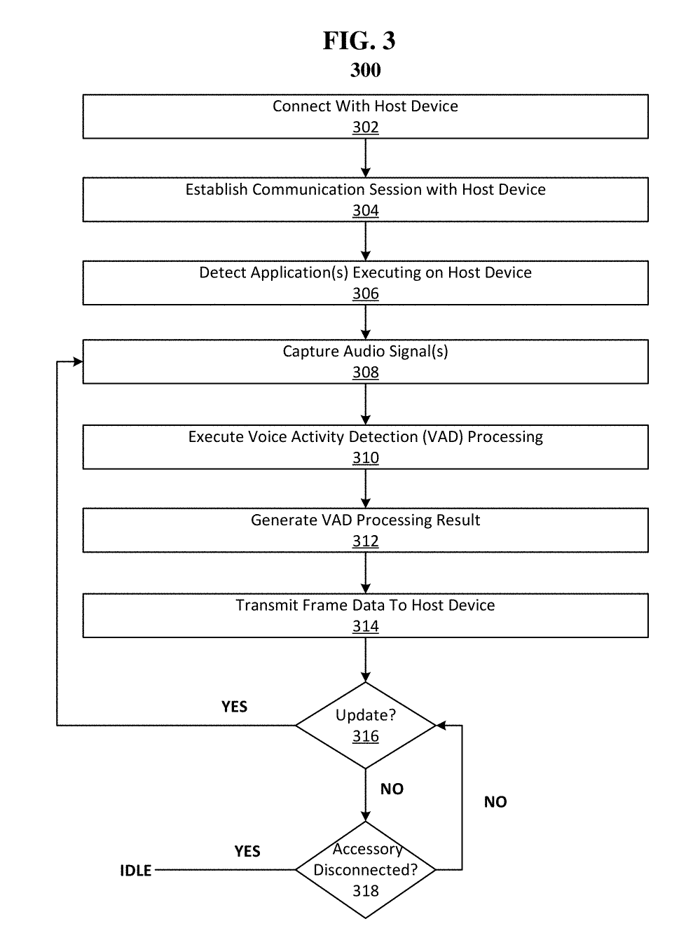

FIG. 1A illustrates an exemplary system 100 implementable on one or more computing devices on which aspects of the present disclosure may be practiced. System 100 may be an exemplary system for data transmission between a host device (e.g. host HID) and an accessory device (e.g. accessory HID). Components of system 100 may be hardware components or software implemented on and/or executed by hardware components. In examples, system 100 may include any of hardware components (e.g., ASIC, other devices used to execute/run an OS, and software components (e.g., applications, application programming interfaces, modules, virtual machines, runtime libraries) running on hardware. In one example, an exemplary system 100 may provide an environment for software components to run, obey constraints set for operating, and makes use of resources or facilities of the systems/processing devices, where components may be software (e.g., application, program, module) running on one or more processing devices. For instance, software (e.g., applications, operational instructions, modules) may be executed on a processing device such as a computer, mobile device (e.g., smartphone/phone, tablet) and/or any other type of electronic devices. As an example of a processing device operating environment, refer to operating environments of FIGS. 4-6. One or more components of system 100 may be configured to execute any of the processing operations described in at least method 200 (described in the description of FIG. 2) and method 300 (described in the description of FIG. 3). In other examples, the components of systems disclosed herein may be spread across multiple devices. Exemplary system 100 comprises an exemplary accessory device 106 that comprises application components of: a data exchange component 108, a voice activity detection component 110, a microphone array component 112 and a sensor component 114.

One or more data stores/storages or other memory may be associated with system 100. For example, a component of system 100 may have one or more data storage(s) associated therewith. Data associated with a component of system 100 may be stored thereon as well as processing operations/instructions executed by a component of system 100. Furthermore, it is presented that application components of system 100 may interface with other application services, which are described herein.

In FIG. 1A, processing device 102 may be any device comprising at least one processor and at least one memory/storage. Processing device 102 may be a device as described in the description of FIGS. 4-6. As an example, processing device 102 is a host human interface device (HID). Examples of processing device 102 may include but are not limited to: processing devices such as desktop computers, servers, phones, tablets, phablets, slates, laptops, watches, and any other collection of electrical components such as devices having one or more processors or circuits. In one example processing device 102 may be a device of a user that is executing applications/services. In examples, processing device 102 may communicate with the accessory HID 106 via a data transmission standard 104. A data transmission standard 104 a means of communication that may utilize a communication protocol to connect devices. In one example, a data transmission standard 104 may be a wireless technology standard (e.g. Bluetooth, USB, infrared, etc.) that can connect a host HID (processing device 102) with an accessory HID 106. In other examples, the data transmission standard 104 may be a wired connection (e.g. USB cable connection).

Processing device 102 is configured to execute applications/services that may receive sound signals as well as processing results of voice activity detection processing by an exemplary accessory HID 106. As an example, an exemplary application is a media call application. For ease of understanding, subsequent examples may refer to an application as a media call application. However, examples described herein may be configured to work with any type of application/service (or a suite of applications/service) executing on a host device.

An exemplary media call application is configured to provide services to enable call/media communication between a computing device and one or more other computing devices and/or telephones. In one example the media call application is configured to deliver communications (e.g. in a communication session) over an IP network such as the Internet, for example, via a voice over internet protocol (VoIP) communication. In another example, the media call application is configured to enable a communication session over a public switched telephone network (PSTN), for example, through an application. In further examples, an exemplary media call application may be involved in a call communication that includes both VoIP and PSTN devices. Examples of exemplary media call applications include but are not limited to: Skype®, Skype For Business®, SkypeOut® and SkypeIn®, among other examples. An exemplary media call application may comprise components configured to encode and/or decode data streams.

A connection may be established for a call communication by one or more of PSTN and/or IP telephony with the computing device and one or more other computing devices or telephonic devices. An exemplary media call application may be configured to enable users to connect via voice calls or VoIP calls, where an exemplary communication session may extend capabilities of the media call application/service by providing functionality including but not limited to: video capabilities (e.g. through a web camera), text/SMS messaging capabilities, handwritten input processing, recording capabilities, an ability to access exemplary message content, an ability to share documents and/or displays, an ability to create conference calls, and ability to manage communication sessions and/or contact information, among other examples. Other components and/or services provided by media call applications are known to one skilled in the field of art. In examples, an exemplary media call application may interface with a component of a distributed network to receive configuration information for an exemplary call communication.

A call communication is an instance within the media call application where a connection is established with one or more participants. A participant is a user of an exemplary media call application/service. A participant is associated with a user account. In one example, the user account is specific to the media call application/service. In another example, the user account is a universal log-in for a plurality of applications/services, for example, provided by a platform. In examples, a call communication may comprise one or more of: video, audio, messaging and access to other application services.

As identified above, an exemplary media call application may interface with other application services. Application services may be any resource that may extend functionality of one or more components of the media call application and/or associated service. Application services may include but are not limited to: personal intelligent assistant services, productivity applications including word processing applications, spreadsheet applications, presentation applications, notes applications, web search services, e-mail applications, calendars, device management services, address book services, informational services, line-of-business (LOB) management services, customer relationship management (CRM) services, debugging services, accounting services, payroll services and services and/or websites that are hosted or controlled by third parties, among other examples. Application services may further include other websites and/or applications hosted by third parties such as social media websites; photo sharing websites; video and music streaming websites; search engine websites; sports, news or entertainment websites, and the like. Application services may further provide analytics, data compilation and/or storage service, etc.

The accessory HID 106 is an example of a peripheral device that may connect with processing device 102 (acting as the host device). As an example, the accessory HID 106 may be a headset device that comprises a headset mounting structure comprising (e.g. housing) the components of accessory HID 106. However, an accessory HID 106 is not limited to such an example and may be any type of device including but not limited to: mobile computing devices, control devices (e.g. remote controls, keyboards, mice) and audio devices, among other examples. Accessory HID 106 comprises: a data exchange component 108, a VAD component 110, a microphone array component 112 and a sensor component 114.

A new configuration for accessory HID 106 is disclosed herein. As an example, accessory HID 106 is configured to interface with an exemplary HID communication protocol, which improves processing between the accessory HID 106 and an HID host device. As an example, the accessory HID 106 can communicate directly with an application executing on an HID host device. In some instances, the accessory HID 106 is configured to provide application-specific data to an application executing on an HID host device. For example, an exemplary accessory HID 106 may be configured to work with a suite of applications (e.g. associated with a specific platform). However, in other examples, the accessory HID 106 is configured to work with any type of host device, where HID commands provided through the HID communication protocol enable data (including audio signals and voice activity detection processing) to be passed to a specific application. Further, the configuration and processing operations executed by the accessory HID 106 improve accuracy in VAD processing. For instance, a configuration of HID 106 comprises multiple booms and a dual microphone array that includes a microphone array in each of the multiple booms. Examples of configuration of exemplary booms of the accessory HID 106 are further provided in the description of the microphone array component 112.

In some examples, accessory HID 106 may be certified as having a level of accuracy for voice activity detection processing where an accessory device may be required to satisfy accuracy requirements for compatibility with an exemplary HID communication protocol. As an example, a threshold level for accuracy in VAD processing may be maintained, where a false positive rate is negligible (e.g. <0.1 percent). Too often, accessory devices do not maintain quality standards for voice activity detection processing. A listing of certified accessory devices that are certified to work with an exemplary HID communication protocol may be maintained and distributed. In examples, certification of HID accessory device (e.g. accessory HID 106) may occur based on a vendor ID and/or a product ID. Additionally, an exemplary accessory HID 106 may be configured to collect and report results of VAD processing. For instance, HID commands associated with an exemplary HID communication protocol may be configured to report (either directly or through an HID host device/application) VAD processing results for subsequent analysis. Results of VAD processing may be analyzed and utilized to make improvements through (software and associated updates). This may ensure that quality standards are met for accessory devices.

The accessory HID 106 may interface with a host device through the exemplary HID communication protocol. The HID communication protocol may be an extension of a standard that is used for communication between a host device and an accessory device. The HID communication protocol of the present disclosure is configured to enable the accessory device to directly communicate with an application of a host device as well as tailor communications in an application-specific manner for the application. As an example, the HID protocol may be an extension of a Bluetooth HID standard that can adapt an existing Bluetooth protocol to enable application-specific communications with an accessory device. As another example, the HID protocol may be an extension of a universal serial bus (USB) standard that can adapt an existing USB protocol to enable application-specific communications with an accessory device. An exemplary HID communication protocol may be extension of audio class data for a USB/BT standard, where audio data format transmitted may be modified to include metadata such as VAD data, device state data (e.g. HID accessory device and/or HID host device), signal path states, etc. For instance, an audio class data payload may be extended to enable transmission of such information. Extending audio class data may ensure that audio frame data and VAD status are synchronized. In further examples, an exemplary payload may be further modified to include data for application-specific communications between an application (executing on an HID host device) and the accessory HID 106, for example, where data for feature control (e.g. VAD features, features for silence suppression, muting control, etc.), among other examples, may be transmitted between the accessory HID 106 and an application. In alternate examples, an accessory HID 106 may be configured to communicate with an application/service through HID command processing, where an exemplary HID communication protocol is configured to implement programmed commands to manage data exchange between an application/service executing on an HID host and the accessory HID 106.

The data exchange component 108 is a component configured for connecting to and communicating with a host device (processing device 102, host HID). The accessory HID 106 is a headset device, where the data exchange component 108 is housed within or connected to a headset mounting structure. In at least one example, the data exchange component 108 comprises a switch for controlling signal processing. For instance, the data exchange component 108 may be exposed on the headset mounting structure, enabling a user to toggle a signal for switching the accessory HID 106 on or off. The data exchange component 108 may comprise one or more components such as a memory and/or a processor. As an example, the data exchange component 108 may be a Bluetooth component or a universal serial bus (USB) component. In one instance, the data exchange component 108 may be a processing component that is configured for short-range communication with processing device 102. For example, the data exchange component 108 may interface with processing device 102 through radio waves/signals or alternatively a wired connection.

The accessory HID 106 communicates directly with an application executing on the host device through a communication protocol that is managed by the data exchange component 108. As an example, accessory HID 106 may be switched on (or directly connected with processing device 102) to initiate a connection with processing device 102. Processing operations for detection of a signal and establishing a connection with processing device 102 are known to one skilled in the art. In further examples, one or more HID APIs may be configured to enable the accessory HID 106 to communicate with a host device (processing device 102). In one example, an HID API is configured to manage device discovery and setup. For instance, devices (e.g. host and accessory devices) may be identified by hardware identification or a specific HID collection that comprises a grouping of HID controls and HID usages. Developers may tailor an exemplary HID communication protocol to include new HID controls and HID usages that enable identification of applications and application-specific communication with an accessory HID 106. Examples of processing operations executed by an exemplary data exchange component 108 include processing operations described in method 300 (FIG. 3).

The accessory HID may further comprise a voice activity detection component 110 that is configured to capture and process sound signals. In doing so, the voice activity detection component may execute voice activity detection (VAD) processing. In one example, the accessory HID 106 is a headset device, where the voice activity detection component 110 is housed within (e.g. embedded) in the headset mounting structure. As an example, a voice activity detection component 110 may comprise one or more components such as a memory and/or a processor. In one example, a voice activity detection component 110 may be included in a speaker chamber of the headset mounting structure, for example, that is component of a microphone boom of the headset mounting structure. Examples of VAD processing operations are further described in the description of method 200 (FIG. 2) and method 300 (FIG. 3).

Voice activity detection can be done much more reliably in the accessory device than in host device software as the accessory device may be closer to the source of a sound signal. In examples where an accessory HID 106 is a headset, multiple microphone arrays that may be used to distinguish user's speech from surrounding sound sources. Thus, an accessory device could indicate voice activity periods and the communication software could react by appropriate signal gain settings better than an HID host device that may take longer (e.g. VAD processing delay) to process audio signal data. Increases in gain could be avoided, or gain could be lowered during passive time segments. The accessory HID 106 is configured to collect and process sound signals in instances where microphones are muted as well as when the microphones are not muted. That, is an exemplary accessory HID 106 is configured to execute VAD processing even while a signal path for the accessory HID 106 is muted. An exemplary accessory HID 106 may be configured to include a smart mute feature with dynamic time warping that, through interfacing with an exemplary application (e.g. media call application), would enable a user to mute/unmute an application directly from the accessory HID 106. In some instances, the smart mute feature of the accessory HID 106 may be configured to use VAD processing results to automatically mute or unmute the accessory HID 106 and/or the application/service. Processing related to an exemplary smart mute feature is achieved through the HID communication protocol that enables direct communication between an application and the accessory HID 106 and accounts for a delay in VAD processing without requiring modification of a payload during data transmission. In further instances, captured VAD signals may be processed, where processing results may be transmitted to (and used by) other applications (such as VoIP applications/services).

The accessory HID 106 may capture one or more sound signals. In some instances, a user may have one or more microphone booms (of an accessory device) positioned away from the user's mouth, which could lead to difficulty in capturing audio/sound signals. An exemplary accessory HID 106 may be configured to detect such an instance and notify a user. Examples of notification may comprise but are not limited to: audio output through the accessory device, visual indication on the accessory device and data transmission provided to an application for the application to provide a notification to a user, among other examples.

VAD processing, executed by the voice activity detection component 110, may comprise multiple processing stages through a trained model. For instance, VAD processing may comprise a capture stage, a noise reduction stage, a featurization/evaluation stage and a classification stage (e.g. classify sound signal as speech or non-speech). Furthermore, the voice activity detection component 110 interfaces with other processing components of the accessory HID 106 to provide an enhanced voice activity detection model to improve accuracy in VAD processing and signal classification. The accessory HID 106 may execute voice activity detection processing on the one or more sound signals. In one example, execution of the voice activity detection processing comprises applying a trained voice activity detection model to determine a voice activity detection processing result. An exemplary voice activity detection model utilizes a configuration of the accessory HID 106 to analyze a variety of aspects associated with the capture of a sound signal. The voice activity detection model, applied by the voice activity detection component 110, is trained to detect speech in the presence of a range of very diverse types of acoustic background noise. The configuration of the exemplary accessory HID 106 enables captured sound signals to be analyzed in different ways. An exemplary VAD model may be trained offline and/or updated in real-time. The voice activity detection model of the accessory HID 106 may be a learning model that is continuously updated, for example, through data transmission (e.g. by updates received through the data exchange component 108).

Application of the trained voice activity detection model may comprise evaluating one or more of: a level of the one or more sound signals detected by a microphone array/microphone arrays of the exemplary accessory HID 106, detection of one or more of a head position and a gaze position of a user who wears the accessory HID 106, a state of a signal path of the accessory HID 106 and a confirmation of a user-specific speech pattern of the one or more sound signals. An exemplary processing result may be generated based on an evaluation of the one or more sound signals. The processing result (and captured sound signal) may be transmitted to the detected application through a communication session established through the HID communication protocol.

In executing VAD processing, the trained voice activity detection model can also factor in other aspects such as a state of signal path of the accessory HID 106. In examples, an accessory HID 106 may comprise one or more signal path or channels for communication. The voice activity detection model is configured to evaluate whether a signal path is muted at a time when sound signal is being received. Such an evaluation can be help a VAD model generate a processing result and indicate specific actions the accessory HID 106 may take during processing of sound signals. In one example, the accessory HID 106 is configured to indicate a state of a voice activity detection state (e.g. that a capture signal path is muted). A host device and/or application executing on a host device could notice this and notify the user without actually receiving the sound signal. Thus, user's privacy would be preserved while a typical error could be avoided. In another example, the voice activity detection component 110, through analysis associate with an exemplary smart mute feature, is configured to automatically un-mute a signal path of the accessory device based on detecting that the signal path is muted and determining that a level of one or more sound signals exceeds a threshold for detecting voice activity. That is, a VAD detection state, in combination with a VAD processing result, may be used to manipulate a state of the accessory HID 106. This may improve processing efficiency as well as a user interaction with an accessory HID 106. In some examples, functionality related to automatic muting/un-muting may be adjustable by a user, through the accessory HID 106, an application/service for the accessory HID 106 and/or an application executing on a host device that is receiving signal transmission.

In executing VAD processing, the trained voice activity detection model can also factor in other aspects such as a confirmation of a user-specific speech pattern of the one or more sound signals. The voice activity detection model may be trained based on speech samples from one or more users. In one instance, audio samples for training of the voice activity detection model may be received from one or more applications/services including an exemplary media call application. In another example, a user may provide a sound/audio sample that is associated with a specific user profile that the voice activity detection model can utilize to compare with a newly received audio signal. That is, in some examples, the voice activity detection model may be configured to use previously processed audio signals for a user to assist with evaluation/classification of received audio signals. In examples where a speech sample has not been collected for a specific user, the accessory device may be configured to collect a baseline audio signal from a real-time communication to use for an evaluation of subsequent audio signals.

A received audio signal may be compared with sounds samples and evaluated based on a threshold determination/determinations that may evaluate one or more of: language features, prosodic features and/or acoustic features. In one instance, matching a received sound signal to that of a user-specific speech pattern can help identify that an audio signal is intended for transmission. As an example, a single user at a specific location may be an active participant in a call communication. Another user may walk into the location provide speech signal that is unintended for the call communication. However, the speech of the other user may be intended for the call communication. In any case, the voice activity detection model is configured to provide capability of evaluating speech as a corollary feature for a comprehensive analysis of an audio signal.

In executing VAD processing, the voice activity detection model may be configured to execute a weighted determination of the above referenced factors to provide a comprehensive evaluation of an audio signal. Weighting associated with particular features may be set by developers and can also be adjusted based on learning/training of the voice activity detection model. For instance, a threshold evaluation aimed at classifying an audio signal as speech or non-speech may carry more weight than an evaluation of a user-specific speech pattern or a head position/gaze position. Weighting can also be impacted by the amount of data that is available to the voice activity detection model in a specific situation.

The voice activity detection component 110 may generate a processing result based on an execution of VAD processing. The processing result (e.g. VAD processing result) may comprise any data that is usable by an application/service, executing on a host device, so that the application does not have to execute redundant VAD processing. The processing result is aimed to cascade VAD processing so redundant voice activity detection does not have to be performed by an application/service executing on a host device. In one example, the processing result may comprise one or more signals communication results of VAD processing such as: audio signal classification, user-specific pattern evaluation, head or gaze position and state of a signal path, among other examples. In some cases, additional aspects (different aspects) of an audio signal may be evaluated by the application in addition to the VAD processing. In examples where the voice activity detection component 110 classifies the audio signal as speech (e.g. intended speech), the audio signal is provided to the application for output. Additional data regarding an evaluation of the audio signal (e.g. based on VAD processing) may also be communicated to an application through an established communication session that is initiated through an exemplary HID communication protocol (previously described). A processing result may be periodically updated, where a processing state of the accessory HID 106 is communicated to an application (on a host device) through an exemplary communication session established by the HID communication protocol.

The accessory HID 106 may further comprise a microphone array component 112 that is configured to assist the voice activity detection component 110 with VAD processing. The microphone array component 112 may be figured to interface with the voice activity detection component 110 to pass received audio signals for VAD processing. In examples, the microphone array component 112 may be a combination of at least two microphones, where one or more microphones is included in a first boom of the headset mounting structure and one or more other microphones are included in a second boom of the headset mounting structure. The microphone array component 112 may be configured to detect audio signals and interface with the voice activity detection component 110 for processing of the detected audio signals.

In evaluating a level of the one or more audio signals detected by a microphone array of the exemplary accessory HID 106, the voice activity model may be trained using samples of speech and non-speech audio signals. A threshold evaluation may be performed to evaluate specific audio signals. As an example, a threshold may be set based on a strength of an audio signal (e.g. sound level) detected by the microphone array configuration of the accessory HID 106. An exemplary threshold may also factor in a signal-to-noise ratio for a received audio signal. As an example, the accessory HID 106 may comprise two booms positioned on opposite sides of a headset mounting structure, where a length of each boom is proximal to a speaking point (e.g. mouth) of a user. For instance, a length of an exemplary boom of the accessory HID 106 is shorter/shortened as compared with boom configurations of traditional headsets, where the accessory HID 106 comprises two or more booms that remain in proximity to a speaking point of a user. Typically, traditional headsets include a single boom that is elongated in a manner where a microphone is positioned further away from a speaking point of a user. A distal configuration of a boom on a traditional headset boom can reduce accuracy when evaluating audio signals in comparison with the boom configuration of the accessory HID 106. With a single boom configuration, traditional headsets may frequently detect false positives (e.g. misclassification of sound signals) when executing VAD processing. A high rate of false positive detections can greatly hinder a user experience and satisfaction with a headset device. The multi-boom microphone array configuration of accessory HID 106 improves accuracy when executing VAD processing. Additionally, an exemplary accessory HID 106 is configured to apply modeling that can further improve accuracy when classifying audio signals.

A microphone array, provided by the microphone array component 112, is optimally configured to improve accuracy in differentiating speech signals from non-speech signals. The voice activity detection model may be trained to evaluate a strength of an audio signal (e.g. sound level) as detected by multiple microphones of the accessory HID 106. For instance, an optimal configuration for the accessory HID 106 is a dual microphone array. In the exemplary dual microphone array, one or more microphones on each side of a headset mounting structure, where the microphones are closely adjacent to a position where a user (of the accessory HID 106) may speak from. That is, the accessory HID 106 positions microphones symmetrically on the left/right side of the mouth of a user. Traditional headset devices may comprise a microphone array that is on only one side of a headset device. The dual microphone array configuration of the accessory HID 106 can optimize accuracy in sound signal classification and speech detection as compared with that of a traditional headset. Among other benefits, false positives for classification of a sound signal as speech can be reduced as compared with a traditional headset configuration. Traditional headsets that have speaking with muted alerting capabilities are limited for accuracy in classifying a sound signal since they try to use one-sided arrays.

In one example, one or more microphones of the microphone array component 112 are positioned in a first boom of the headset mounting structure and one or more additional microphones are positioned in a second boom of a headset mounting structure, where the first and second boom are on opposite sides of the headset mounting structure. In some examples, the headset mounting structure and/or components of the headset mounting structure may be adjustable. For example, booms of an accessory HID 106 may be adjustable. In other examples, booms of the accessory HID 106 may be set in a fixed position in proximity to an estimated speaking point of a user.

In other examples, the booms of the accessory HID 106 are fixed to move along a specific plane/axis. For instance, mobility of the booms may be restricted so that the booms can only be moved in an upward or downward direction. That is, the booms of the accessory HID 106 can be configured to move in a vertical alignment, where the booms can be positioned in a first state (e.g. booms facing upwards, which is not optimal for voice activity detection) and a second state (e.g. booms optimally positioned closest to a speaking point of a user). Horizontal arrangement/movement of the booms may be restricted so as not to affect accuracy in VAD processing.

The accessory HID 106 is further configured to detect a position of the microphone booms, for example, to optimize accuracy in voice activity detection. For instance, if one or more of the booms are positioned in a first state (e.g. facing upwards and away from a speaking point of a user), which is not optimal for voice activity detection processing, the accessory HID 106 is configured to provide a notification to the user to adjust a boom. The accessory HID 106 is configured to detect the position of the boom and provide notification either: directly from the accessory HID 106 or through communication with the application/service. In one example, the accessory HID 106 may be configured to detect that one or more of the microphone booms are not optimally positioned for voice activity detection (e.g. boom is facing upwards and away from a speaking point of the user) and provide/output an audio notification to the user to adjust one or more of the microphone booms. In another example, the HID communication protocol may be utilized to transmit a notification of boom positioning to the application/service, where notification can be displayed through the application/service. In such examples, the accessory HID 106 may comprise additional sensors that can be used to detect positions of the microphone booms, where the accessory HID 106 is configured to detect positioning and evaluate the positioning for optimal sound signal collection and processing. Additional sensor components may be included within the accessory HID 106, for example, to improve the accessory HID 106 ability to execute accurate VAD processing. Further sensor examples are provided in the description of the sensor components 114.

The trained voice activity detection model can also factor in other aspects in helping to identify speech as being intended or not. The accessory HID 106 may be configured to comprise one or more sensor components 114. In one example, the accessory HID 106 is a headset device, where the sensor component 114 are housed within or connected to a headset mounting structure. Alternatively, sensors may be exposed to provide improved accuracy for detection of user characteristics such as a head position or eye gaze position. For example, if a head position or gaze position of a user is facing a display (e.g. of processing device 102), it may be more likely that a user is intending a speech signal for transmission. While this may not hold true in all instances, it should be recognized that readings from sensors of an exemplary accessory HID 106 may be useful in a collective evaluation for VAD processing executed by the exemplary voice activity detection model.

As an example, the headset mounting structure of the accessory HID 106 further comprises at least one sensor configured for detecting a gaze position of a user that wears the device. In another example, the headset mounting structure of the accessory HID 106 further comprises at least one sensor configured for detecting a head position of a user that wears the device. Examples of sensors that are optimal for wearable devices such as an exemplary accessory HID 106 are known to one skilled in the art. Positioning of one or more sensory components 114 may vary to optimize accuracy in determining a head position or a gaze position of a user.

FIG. 1B illustrates an exemplary accessory device 120 with which aspects of the present disclosure may be practiced. Accessory device 120 may comprise any of the components of the accessory HID 106 (described in the description of FIG. 1A). Accessory device 120 is a headset device that comprises a headset mounting structure 122. Additional description related to a headset mounting structure (e.g. headset mounting structure 122) is provided in the description of FIG. 1A. The headset mounting structure 122 may comprise a set of headphones 124 where a first headphone is positioned on a left side of the headset mounting structure 122 and a second headphone is positioned on a right side of the headset mounting structure 122. The headphones 124 are electroacoustic transducers, which convert an electrical signal to a corresponding sound in an ear of a user.

The headset mounting structure 122 may further comprise microphone booms, which are examples of a microphone array component 112 (described in the description of FIG. 1A). Accessory device 120 comprises a first boom and a second boom that each comprise at least one microphone, collectively forming a microphone array for capture of an audio signal. In some examples, the headset mounting structure 122 and/or components of the headset mounting structure may be adjustable. For example, booms of an accessory device 120 may be adjustable. In other examples, booms of the accessory device 120 may be set in a fixed position in proximity to an estimated speaking point of a user. In other examples, the booms of the accessory device 120 are fixed to move along a specific plane/axis. For instance, mobility of the booms may be restricted so that the booms can only be moved in an upward or downward direction. That is, the booms of the accessory device 120 can be configured to move in a vertical alignment, where the booms can be positioned in a first state (e.g. booms facing upwards, which is not optimal for voice activity detection) and a second state (e.g. booms optimally positioned closest to a speaking point of a user). Horizontal arrangement/movement of the booms may be restricted so as not to affect accuracy in VAD processing.

The accessory device 120 may capture one or more audio signals through the microphone array component 112. Audio processing capabilities of the accessory device 120 may be embedded within the headset mounting structure 122. In one example, memory and processing units for voice activity detection (including identification of VAD state and generation of VAD processing results) may be embedded within a speaker chamber of the microphone booms. Furthermore, the headset mounting structure 122 may comprise position sensors (not shown but described in the description of FIG. 1A), which can be embedded into the headset mounting structure 122. Examples of positional sensors may comprise sensors for detection of a head position of a user. In further examples, positional sensors comprise sensors for detection of a gaze position of a user. Other exemplary sensors that may be included in the headset mounting structure comprise but are not limited to: electronic sensors that may be used in conjunction with other electrical devices such as a transceiver (and monitor) for collection and analysis of signal data.

In some instances, a user may have one or more microphone booms (of an accessory device) positioned away from the user's mouth, which could lead to difficulty in capturing audio signals. An exemplary accessory device may be configured to detect such an instance and notify a user. Examples of notification may comprise but are not limited to: audio output through the accessory device, visual indication on the accessory device and data transmission provided to an application for the application to provide a notification to a user, among other examples. In one instance, if one or more microphone booms are not optimally positioned for voice activity detection, a voice activity detection state (identified by the accessory device 120 and transmitted to an application of a host device) may comprise an indication that one or more of the positioning of the first boom and the positioning of the second boom is not optimal for voice activity detection processing.

In further examples, the accessory device 120 is configured to execute VAD processing even while a signal path for signal capture is muted. Accessory device 120 is configured to include a smart mute feature with dynamic time warping that, through interfacing with an exemplary application (e.g. media call application), would enable a user to mute/unmute an application directly from the accessory device 120. In some instances, the smart mute feature of the accessory device 120 may be configured to use VAD processing results to automatically mute or unmute the accessory device 120 and/or the application/service (e.g. where a sound signal is muted within an application/service).

The accessory device 120 is further configured to enable voice activity detection based on sound source localization and/or a user-specific voice activity detection (e.g. trained to a person's voice characteristics). In one example, the accessory device 120 is configured to perform sound source localization to determine whether to enable/disable VAD processing of an audio signal. For instance, an accessory device 120 may be configured with sensors and/or microphones at different positions throughout the headset mounting structure. Receipt of an audio signal at the different points/positions of the headset mounting structure may be analyzed to generate a sound source localization determination, which may be used to determine whether to enable/disable VAD processing of an audio signal. For instance, the accessory device 120 (e.g. processing component thereof) is configured to execute array analysis pertaining to a time of arrival of sound captured at different points of the accessory device. In one example, a threshold evaluation of time of arrival (e.g. in microseconds) may be used to evaluate symmetry of analyzed arrays to determine whether sound is coming from either the mouth of a user wearing the accessory device or from external sounds that should not activate the VAD. In alternate examples, a sound source localization determination can be used to pinpoint a location of an audio signal (e.g. behind the user, above the user, etc.).

In some instances, further processing analysis may be executed based on the sound source localization determination. For example, in an instance where the sound source localization determination identifies that an audio signal is coming from a source that is approximately in front of the person, the accessory device 120 may be configured to execute processing to further evaluate user-specific characteristics of the audio signal in order to determine whether to enable/disable VAD processing of the audio signal. A user-specific model can be trained to evaluate audio signals based on a speech pattern of a specific user (or trained based on training data from a plurality of users). For instance, if a speech pattern does not match that of a user of the accessory device, VAD processing may not be automatically initiated or microphone arrays of the accessory device may be muted. In such examples, the accessory device 120 may be configured to communicate with a host device (e.g. through an exemplary HID communication protocol) to communicate a VAD processing state of the accessory device 120 (e.g. microphone muted), where a user may be able to take manual action to toggle a state of VAD processing of the accessory device 120.

In an example where the sound source localization determination identifies that an audio signal is coming from the mouth of a user wearing the accessory device 120, the accessory device 120 is configured to automatically enable VAD processing of the audio signal. In an example where the sound source localization determination identifies that an audio signal is coming from approximately in front of the person and a user-specific speech pattern for the user is confirmed, the accessory device 120 is configured to automatically enable VAD processing of the audio signal. In at least one instance, enabling of VAD processing of the audio signal may comprise automatically un-muting a microphone of the accessory device 120.

FIG. 2 is an exemplary method 200 related to application processing by an application executing on a host device with which aspects of the present disclosure may be practiced. As an example, method 200 may be executed by an exemplary processing device and/or system such as those shown in FIGS. 4-6. In examples, method 200 may execute on a device comprising at least one processor configured to store and execute operations, programs or instructions. Operations performed in method 200 may correspond to operations executed by a system and/or service that execute computer programs, application programming interfaces (APIs), neural networks or machine-learning processing, among other examples. As an example, processing operations executed in method 200 may be performed by one or more hardware components. In another example, processing operations executed in method 200 may be performed by one or more software components. In some examples, processing operations described in method 200 may be executed by one or more applications/services associated with a web service that has access to a plurality of application/services, devices, knowledge resources, etc. Processing operations described in method 200 may be implemented by one or more components connected over a distributed network, for example, as described in system 100 (of FIG. 1A).

Method 200 begins at processing operation 202, where a connection is detected with an exemplary accessory device. As an example, a connection with an accessory may be detected by a host device. A host device may be any computing device that is configured to execute on or more applications/services. Examples of computing devices are provided in the description of FIGS. 4-6 provided herein. As an example, an accessory device is accessory HID 106 as described in FIG. 1A. However, an accessory device is not limited to such an example and may be any type of device including but not limited to: mobile computing devices, control devices (e.g. remote controls, headsets, keyboards, mice) and audio devices, among other examples. Processing operation 202 may comprise communication with the accessory device through a data transmission standard (e.g. Bluetooth or USB connection) as described with reference to the data exchange component 108 of the accessory HID 106 (FIG. 1A). An exemplary host device may be further configured to detect an application executing in a foreground of the host device, for example, where the application may communicate with the accessory device.

Flow may proceed to processing operation 204, where a communication session with the accessory device may be established. As an example, processing operation 204 may establish the communication session based on the detected connection with the accessory device. An exemplary communication session is established through an HID communication protocol that is configured to enable direct communication between an application, executing on the host device, and the accessory device. Examples of the HID communication protocol have been previously provided. A communication session is a semi-permanent interactive information interchange between computing device (e.g. host device and accessory device). The communication session is bi-directional and enables a specific application (e.g. detected foreground application) to communicate directly with the accessory device. Parameters for a communication session may be defined by developers through an API and/or commands associated with an HID standard.

Once an exemplary communication session is established with the accessory device, flow may proceed to processing operation 206, where feature control of application (executing on the host device) may be toggled. As an example, processing operation 206 may comprise modifying one or more feature controls of the application based on communication with an accessory device through the communication session. Any type of control feature of an application may be toggled (processing operation 206) based on communication with the accessory device. Examples of control features that may be toggled include but are not limited to: a voice activity detection feature, a silence suppression feature, quality of service features and resource consumption (e.g. assigned power levels, amount of resources), among other examples. For instance, control of a voice activity detection feature within the application may be toggled based on the established communication session with the accessory device. In one example, a voice activity detection feature within the application may be disabled where VAD processing results, provided by an accessory device, may be used by the application. Disabling of a VAD feature enables the application to defer to the accessory device for VAD processing and prevents redundant VAD processing from being performed. Through commands of the HID communication protocol, the application may receive communication from the accessory device indicating that the accessory device is configured to execute VAD processing. In other examples, the application may be configured to disable a feature associated with VAD processing when detecting a connection with the accessory HID 106 (as described in the description of FIG. 1A).

During an exemplary communication session, the application may receive (processing operation 208) frame data from the accessing device. Frame data may be periodically received from the accessory device through the communication session. Extension of an HID standard through an exemplary HID communication protocol may enable manipulation of frame data, where the frame data is optimized for communication between an accessory device and an application/service. For instance, an accessory device may include, in frame data, voice activity detection state information for the accessory device as well as VAD processing results for received audio signals. In some instances, frame date may comprise a detected audio signal, for example, when the VAD state of the accessory device is unmuted. In one example, an application may receive, through a communication session, a voice activity detection state of the accessory device. For instance, the voice activity detection state may indicate that the accessory device is muted.

Transmission of frame data (including VAD processing results and/or VAD detection state of an accessory device) may occur through the communication session established by the HID communication protocol. An exemplary HID communication protocol may be configured to enable an accessory device to collect and transmit frame data even when a signal path is muted on an accessory device. For example, the application may receive frame data that include audio signal and a VAD processing result (from the accessory device) when the accessory device is muted. In another instance, frame data may not include an audio signal. Instead, a VAD detection state of an accessory device is transmitted to an application executing on a host device. In further examples, a VAD detection state as well as a VAD processing result may be transmitted from the accessory device to the application. Such information may be useful to enable the application to adjust operation of its service, for example, to notify to user that speech is detected while the accessory device is muted. In such an example, efficiency in providing such a notification is improved because the application is not required to perform VAD processing on an audio signal received from an accessory device. Moreover, accuracy in classification of an audio signal may be improved as VAD processing is being performed by the device that detected the audio signal.

In examples of method 200, the application may adjust (processing operation 210) service of the application based on the received frame data. For example, the application may receive the detected VAD state of the accessory device (e.g. identifying that a signal path of the accessory device is muted) and utilize such data to provide a notification to the user that the accessory device is muted. In another example, application may utilize the VAD processing result received from the accessory device, for example, in lieu of executing VAD processing on a received audio signal. In further instances, the application may execute telemetric analysis on VAD processing result and/or the VAD detection state data provided by the accessory device, where analysis can be utilized to update service of the application and/or subsequent updates for an accessory device (e.g. accessory HID).

In further instances, adjustment (processing operation 210) of service of the application may extend to other examples. Consider an example where the application is media call application. The media call application may use a processing result provided by the accessory device to adjust (processing operation 210) one or more of: a quality level of the active call communication, a silence suppression feature of the media call application and power-levels assigned to resources associated with the media call application, among other examples.

In alternate examples of method 200 where an audio signal is to be output, flow may proceed to processing operation 212. At operation 212, an audio signal (received from the accessory device) is output through the application. An audio signal may be output (processing operation 212) through the application, for example, when a VAD state of the accessory device indicates that a signal path for audio capture is unmuted and a VAD processing result indicates that the audio signal is classified as speech. However, example of method 200 are not limited to such instances.

Flow may proceed to decision operation 214, where it is determined whether an update is received from the accessory device. An update may be an update to the audio signal, a VAD processing result and/or an update to a VAD detection state of the accessory device, among other examples. In examples where an update is received from the accessory device, flow branches YES and processing of method 200 returns to processing operation 208, where updated frame data is received from the accessory device. Subsequent communication between the application and the accessory device may occur through the communication session.

In examples where no update is received from the accessory device, flow of method 200 branches NO and processing proceeds to decision operation 216. At decision operation 216, it is determined whether the accessory device is disconnected. If the accessory device remains connected, flow branches NO and processing returns to decision operation 214, where the application may wait for an update from the accessory device. If decision operation determines that the accessory device is disconnected, flow branches YES and processing proceeds to procession operation 218. At processing operation 218, a voice activity detection feature may be re-enabled. Once an accessory device is no longer executing VAD processing, the application may take over control of VAD processing. In instances where other control features were toggled (processing operation 206), additional feature modification may also occur based on disconnection of the accessory device.

FIG. 3 is an exemplary method 300 related to communication, by an accessory device, with a host device with which aspects of the present disclosure may be practiced. As an example, method 300 may be executed by an exemplary processing device and/or system such as those shown in FIGS. 4-6. In examples, method 300 may execute on a device comprising at least one processor configured to store and execute operations, programs or instructions. Operations performed in method 300 may correspond to operations executed by a system and/or service that execute computer programs, application programming interfaces (APIs), neural networks or machine-learning processing, among other examples. As an example, processing operations executed in method 300 may be performed by one or more hardware components. In another example, processing operations executed in method 300 may be performed by one or more software components. In some examples, processing operations described in method 300 may be executed by one or more applications/services associated with a web service that has access to a plurality of application/services, devices, knowledge resources, etc. Processing operations described in method 300 may be implemented by one or more components connected over a distributed network, for example, as described in system 100 (of FIG. 1A).

Method 300 begins at processing operation 302, where an exemplary accessory device may connect with a host device. Examples of accessory devices and host devices as well as connection established therebetween have been described in previous examples. An exemplary accessory device may be accessory HID 106 (as described in the description of FIG. 1A).

Flow may proceed to processing operation 304, where a communication session may be established between the accessory device and the host device. The exemplary HID communication protocol creates the communication session, enabling direct communication between the accessory device and a host device. An exemplary communication session has been described in the foregoing including the description of system 100 (FIG. 1A) and method 200 (FIG. 2). An exemplary communication session may be established based on initiation of a connection between a host device (e.g. host HID) and an accessory device (e.g. accessory HID).

At processing operation 306, an application, executing on the host device, is detected. More specifically, the HID communication protocol may be configured to identify a specific application that is executing on a host device, which can receive audio signals and/or processing results from the accessory device. An application may be detected that is executing in a foreground of the host device. Detection of an application may be based on communication received from a host device that identifies an application in which the accessory device is to communicate with. An exemplary HID communication protocol may be configured to obtain data of executing applications from a host device. In one example, communication may occur through an exemplary communication that is established based on the HID communication protocol. In alternative examples, the host device and/or application may be configured to provide identification to the accessory device based on initiation (processing operation 302) of a connection with an exemplary accessory device.

Flow may proceed to processing operation 308, where the accessory device may capture one or more audio signals. An exemplary accessory device (e.g. accessory HID 106 of FIG. 1) is configured to capture audio signals, for example, from a dual microphone array as described in the foregoing. In some examples, the accessory device is configured to detect a positioning of microphone booms of the accessory device. For instance, a notification may be provided to a user that boom positioning is not optimal for collection and processing of audio signals. Further examples related to detection of boom positioning are described in the description of the accessory HID 106 (of FIG. 1A).

The accessory device may execute (processing operation 310) voice activity detection (VAD) processing on the captured audio signals. Execution of VAD processing has been described in the foregoing examples including the description of system 100 (FIG. 1A). In one example, execution (processing operation 310) of the voice activity detection processing comprises applying a trained voice activity detection model to determine a processing result (e.g. VAD processing result). Application of the trained voice activity detection model may comprise evaluating one or more of: a level of the one or more sound signals detected by microphone arrays of the exemplary accessory device, detection of one or more of a head position and a gaze position of a user who wears the accessory device, a state of a signal path of the accessory device and a confirmation of a user-specific speech pattern of the one or more sound signals. As described above, an exemplary accessory device may execute VAD processing even when a signal path of the accessory device is muted. Processing results for all VAD processing (including when a signal path is muted) may be continuously transmitted to an application/service via an exemplary HID communication protocol.

A processing result (e.g. VAD processing result) may be generated (processing operation 312) based on an evaluation of the one or more sound signals through execution (processing operation 310) of the VAD processing. Examples of a VAD processing result/control result have been described in the foregoing. A generated processing result may be transmitted (processing operation 314) to the detected application through the established communication session.

Flow may proceed to decision operation 316, where it is determined whether an update occurs to the audio signal. In examples where an update is received, flow branches YES and processing returns to processing operation 308, where a new audio signal is captured. Subsequent communication between the application and the accessory device may occur through the communication session based on updated audio signals provided through the accessory device.

In examples where no updated audio signal is received, flow branches NO and processing of method 300 proceeds to decision operation 318. At decision operation 318, it is determined whether the accessory device is disconnected. If the accessory device remains connected, flow branches NO and processing returns to decision operation 316, where the accessory device may wait for audio signal processing. If decision operation determines that the accessory device is disconnected, flow branches YES and processing ends. The accessory device may remain idle until subsequent processing is to be performed.

In further examples, an exemplary accessory device is configured to manage features associated with operation of the accessory device. For instance, the accessory device may be configured to detect whether a signal path of the system is muted. The accessory device may be configured to take action such as automatically un-muting the signal path based on a detection that the signal path is muted and a determination that a level of the one or more audio signals exceeds a threshold for voice activity. In one example, the threshold for voice activity may correspond with a signal strength detected by the microphone array of the accessory device.

FIGS. 4-6 and the associated descriptions provide a discussion of a variety of operating environments in which examples of the invention may be practiced. However, the devices and systems illustrated and discussed with respect to FIGS. 4-6 are for purposes of example and illustration and are not limiting of a vast number of computing device configurations that may be utilized for practicing examples of the invention, described herein.

FIG. 4 is a block diagram illustrating physical components of a computing device 402, for example a mobile processing device, with which examples of the present disclosure may be practiced. Among other examples, computing device 402 may be an exemplary computing device configured as a human interface device (HID) host device or HID accessory device as described herein. In a basic configuration, the computing device 402 may include at least one processing unit 404 and a system memory 406. Depending on the configuration and type of computing device, the system memory 406 may comprise, but is not limited to, volatile storage (e.g., random access memory), non-volatile storage (e.g., read-only memory), flash memory, or any combination of such memories. The system memory 406 may include an operating system 407 and one or more program modules 408 suitable for running software programs/modules 420 such as IO manager 424, other utility 426 and application 428. As examples, system memory 406 may store instructions for execution. Other examples of system memory 406 may store data associated with applications. The operating system 407, for example, may be suitable for controlling the operation of the computing device 402. Furthermore, examples of the invention may be practiced in conjunction with a graphics library, other operating systems, or any other application program and is not limited to any particular application or system. This basic configuration is illustrated in FIG. 4 by those components within a dashed line 422. The computing device 402 may have additional features or functionality. For example, the computing device 402 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 406. While executing on the processing unit 404, program modules 408 (e.g., Input/Output (I/O) manager 424, other utility 426 and application 428) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 402 may also have one or more input device(s) 412 such as a keyboard, a mouse, a pen, a sound input device, a device for voice input/recognition, a touch input device, etc. The output device(s) 414 such as a display, speakers, a printer, etc. may also be included. The aforementioned devices are examples and others may be used. The computing device 404 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 406, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 402. Any such computer storage media may be part of the computing device 402. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

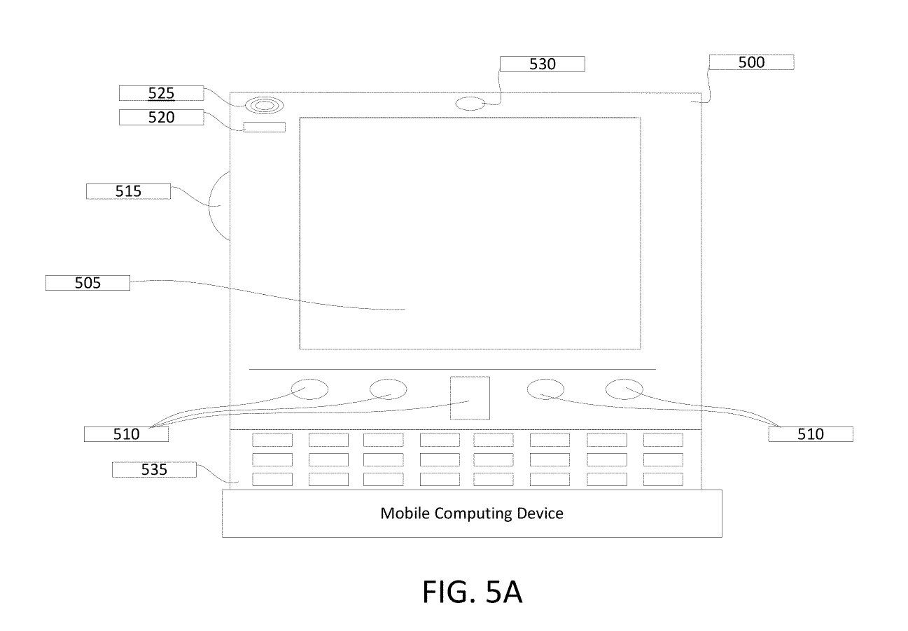

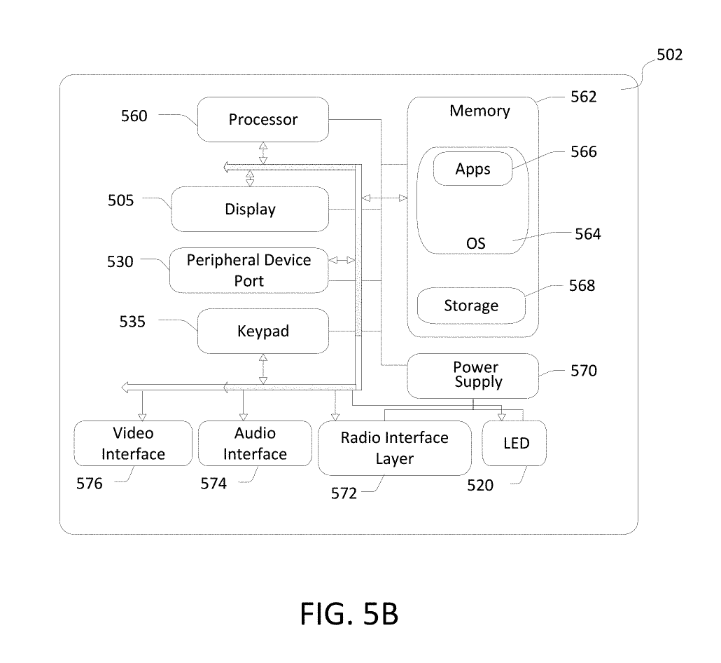

FIGS. 5A and 5B illustrate a mobile computing device 500, for example, a mobile telephone, a smart phone, a personal data assistant, a tablet personal computer, a phablet, a slate, a laptop computer, and the like, with which examples of the invention may be practiced. Mobile computing device 500 may be an exemplary computing device configured as a human interface device (HID) host device or HID accessory device as described herein. Application command control may be provided for applications executing on a computing device such as mobile computing device 500. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 5A, one example of a mobile computing device 500 for implementing the examples is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., touch screen display). If included, an optional side input element 515 allows further user input. The side input element 515 may be a rotary switch, a button, or any other type of manual input element. In alternative examples, mobile computing device 500 may incorporate more or less input elements. For example, the display 505 may not be a touch screen in some examples. In yet another alternative example, the mobile computing device 500 is a portable phone system, such as a cellular phone. The mobile computing device 500 may also include an optional keypad 535. Optional keypad 535 may be a physical keypad or a “soft” keypad generated on the touch screen display or any other soft input panel (SIP). In various examples, the output elements include the display 505 for showing a GUI, a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 can incorporate a system (i.e., an architecture) 502 to implement some examples. In one examples, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA), tablet and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device (e.g. system 502) described herein.

The system 502 has a power supply 570, which may be implemented as one or more batteries. The power supply 570 might further include an external power source, such as an AC adapter or a powered docking cradle that supplements or recharges the batteries.

The system 502 may include peripheral device port 530 that performs the function of facilitating connectivity between system 502 and one or more peripheral devices. Transmissions to and from the peripheral device port 530 are conducted under control of the operating system (OS) 564. In other words, communications received by the peripheral device port 530 may be disseminated to the application programs 566 via the operating system 564, and vice versa.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator 520 may be used to provide visual notifications, and/or an audio interface 574 may be used for producing audible notifications via the audio transducer 525 (as described in the description of mobile computing device 500). In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525 (shown in FIG. 5A), the audio interface 574 may also be coupled to a microphone to receive audible input, such as to facilitate a telephone conversation. In accordance with examples of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

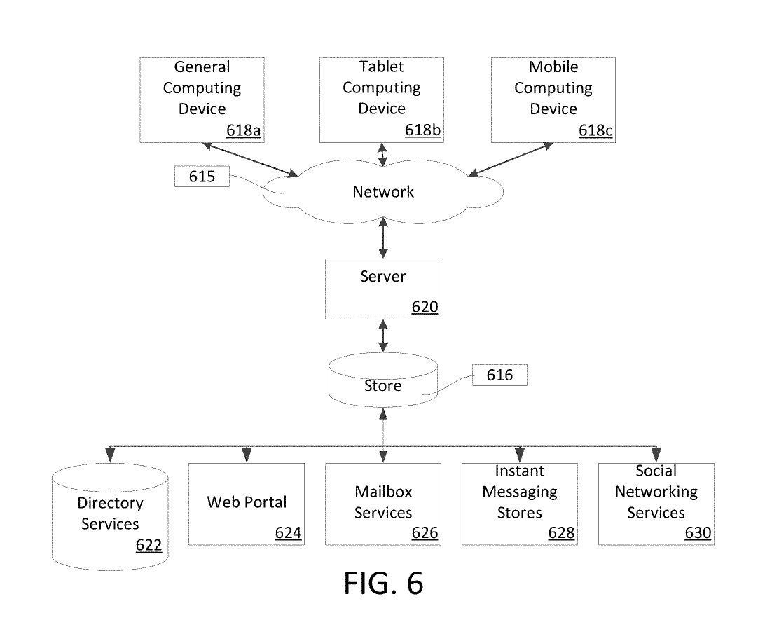

FIG. 6 illustrates one example of the architecture of a system for providing an application that reliably accesses target data on a storage system and handles communication failures to one or more client devices, as described above. The system of FIG. 6 may be an exemplary system configured as a human interface device (HID) host device or HID accessory device as described herein. Target data accessed, interacted with, or edited in association with programming modules 408 and/or applications 420 and storage/memory (described in FIG. 4) may be stored in different communication channels or other storage types. For example, various documents may be stored using a directory service 622, a web portal 624, a mailbox service 626, an instant messaging store 628, or a social networking site 630, application 428, IO manager 424, other utility 426, and storage systems may use any of these types of systems or the like for enabling data utilization, as described herein. A server 620 may provide storage system for use by a client operating on general computing device 402 and mobile device(s) 500 through network 615. By way of example, network 615 may comprise the Internet or any other type of local or wide area network, and a client node may be implemented for connecting to network 615. Examples of a client node comprise but are not limited to: a computing device 402 embodied in a personal computer, a tablet computing device, and/or by a mobile computing device 500 (e.g., mobile processing device). As an example, a client node may connect to the network 615 using a wireless network connection (e.g. WiFi connection, Bluetooth, etc.). However, examples described herein may also extend to connecting to network 615 via a hardwire connection. Any of these examples of the client computing device 402 or 500 may obtain content from the store 616.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. An accessory device comprising:
a headset mounting structure that comprises:
a data exchange component that is configured for connection and communication with a host device,
a first boom and a second boom that are symmetrically aligned at end portions of the headset mounting structure, wherein the first boom and the second boom each comprise at least one microphone that collectively forms a microphone array for capture of an audio signal, and
a voice activity detection component configured for:
identification of a voice activity detection state of the accessory device, and
execution of voice activity detection processing on the audio signal,
wherein the voice activity detection component provides, to the host device, the voice activity detection state of the accessory device.

2. The accessory device of claim 1, wherein the voice activity detection state comprises an indication as to whether a signal path of the accessory device is muted, and where the voice activity detection component is further configured to generate a voice activity detection processing result that classifies the audio signal as speech or non-speech.

3. The accessory device of claim 2, wherein the voice activity detection component is configured to automatically un-mute a signal path of the accessory device when the voice activity detection state indicates that the accessory device is muted and the voice activity processing result classifies the audio signal as speech.

4. The accessory device of claim 2, wherein the voice activity detection component is configured to transmit the voice activity detection processing result to the host device when the voice activity detection state indicates that the accessory device is muted.

5. The accessory device of claim 2, wherein the voice activity detection component is configured to generate the voice activity detection processing result for the audio signal based on applying a voice activity detection model that evaluates: a sound level of the audio signal detected by the microphone array, detection of one or more of a head position and a gaze position of a user that wears the accessory device, and a confirmation of a user-specific speech pattern pertaining to the audio signal.

6. The accessory device of claim 1, wherein the accessory device communicates directly with an application executing on the host device through a human interface device (HID) communication protocol, managed by the data exchange component, that is initiated based on a detection of a connection with the host device, and wherein the application is a media call application that is executing a call communication on behalf of one or more users.

7. The accessory device of claim 1, wherein the voice activity detection component is configured to detect a positioning of the first boom and a positioning of the second boom, and wherein the voice activity detection state comprises an indication that one or more of the positioning of the first boom and the positioning of the second boom is not optimal for voice activity detection processing.

8. The accessory device of claim 1, wherein the headset mounting structure further comprises at least one sensor configured for one or more selected from a group consisting of: detection of a head position of a user that wears the accessory device, and detection of a gaze position of the user.

9. A headset device comprising:
a headset mounting structure that comprises:
a data exchange component that is configured for connecting to and communication with a host device,
a memory that stores computer-executable instructions to execute voice activity detection processing of an audio signal,
at least one processor, operatively connected with the memory, that is configured for execution of the computer-executable instructions, and
a first boom and a second boom that are symmetrically aligned at end portions of the headset mounting structure, wherein the first boom and the second boom each comprise at least one microphone that collectively forms a microphone array for capture of the audio signal.

10. The headset device of claim 9, wherein the at least one processor is configured to: identify a voice activity detection state of the headset device that pertains to whether a signal path of the headset device is muted, and transmit, to the host device, frame data that comprises the voice activity detection state of the headset device.

11. The headset device of claim 10, wherein the at least one processor is configured to: generate a voice activity detection processing result that classifies the audio signal as speech or non-speech, and wherein the frame data, transmitted to the host device, further comprises the voice activity detection processing result.

12. The headset device of claim 11, wherein the voice activity detection processing result is transmitted when the voice activity detection state indicates that the accessory device is muted.

13. The headset device of claim 11, wherein the at least one processor, in executing the computer-executable instructions, is configured to automatically un-mute a signal path of the headset device when the voice activity detection state indicates that the signal path is muted and the voice activity detection processing result classifies the audio signal as speech.

14. The headset device of claim 11, wherein the at least one processor, in executing the computer-executable instructions, is configured to generate the voice activity detection processing result by applying a voice activity detection model that evaluates: a sound level of the audio signal detected by the microphone array, detection of one or more of a head position and a gaze position of a user that is wearing the headset device, and a confirmation of a user-specific speech pattern pertaining to the audio signal.

15. The headset device of claim 9, wherein the at least one processor is configured to: detect a positioning of the first boom and a positioning of the second boom, and wherein the voice activity detection state comprises an indication that one or more of the positioning of the first boom and the positioning of the second boom is not optimal for voice activity detection processing.

16. A system comprising:
a data exchange component that is configured for communication with a host device, wherein the data exchange executes processing operations that comprise:
connecting with the host device,
establishing, through a human interface device (HID) communication protocol, a communication session with a host device, wherein the HID communication protocol enables direct communication between the data exchange component and an application that is executing on the host device; and
a headset mounting structure that comprises:
a first boom and a second boom that are symmetrically aligned at end portions of the headset mounting structure, wherein the first boom and the second boom each comprise at least one microphone that collectively forms a microphone array for capture of an audio signal, and
a voice activity detection component that is configured to execute a method that comprises:
capturing the audio signal,
identifying a voice activity detection state of the system,
executing voice activity detection processing that generates a voice activity detection processing result for classification of the audio signal as speech or non-speech, and
transmitting, to the application, frame data that comprises the voice activity detection state and the voice activity detection processing result.

17. The system of claim 16, wherein the system is an accessory headset, and wherein the application executing on the host device is a media call application.

18. The system of claim 16, wherein the voice activity detection component, in executing of the voice activity detection processing, applies a voice activity detection model that generates the voice activity processing result based on evaluation of: a sound level of the audio signal detected by the microphone array, detection of one or more of a head position and a gaze position of a user that is wearing the headset mounting structure, and a confirmation of a user-specific speech pattern pertaining to the captured audio signal.

19. The system of claim 16, wherein the voice activity detection component, in executing of the voice activity detection processing, detects a positioning of the first boom and a positioning of the second boom, and wherein the voice activity detection state comprises an indication that one or more of the positioning of the first boom and the positioning of the second boom is not optimal for voice activity detection processing.

20. The system of claim 16, wherein the voice activity detection state indicates whether a signal path of the system is muted, and wherein the voice activity detection component is configured to automatically unmute the signal path of the system when the voice activity detection state indicates that the signal path is muted and the voice activity detection processing result classifies the audio signal as speech.
